(19) United States
(12) Patent Application Publication
(10) Pub. No.: US 2025/0282485 A1
(43) Pub. Date: Sep. 11, 2025

(54) AIRCRAFT ACOUSTIC PANEL WITH PERFORATED CAVITY WALLS

(71) Applicant: Rohr, Inc., Chula Vista, CA (US)

(72) Inventors: Wentaur E. Chien, San Diego, CA (US); Preston G. McCartney, San Diego, CA (US)

(21) Appl. No.: 18/601,332

(22) Filed: Mar. 11, 2024

(51) Int. Cl. F02K 1/34; F02C 7/24

(52) U.S. Cl. CPC B64D 33/06; F02C 7/24; F05D 2260/96

(57) ABSTRACT

An apparatus for an aircraft includes an acoustic panel. The acoustic panel includes a face skin, a septum, a back skin, a face core and a back core. The face core includes a plurality of face core cavities that extend vertically through the face core from the face skin to the septum. Each face core cavity is fluidly coupled with face skin perforation(s). The back core includes a first wall, a second wall, a first cavity, a second cavity and a third cavity. The first and second cavities extend vertically through the back core from the septum to the back skin. Each of the first and second cavities is fluidly coupled with a respective face core cavity through septum perforation(s). The first cavity is fluidly coupled with the second cavity through first wall perforation(s). The first cavity is fluidly coupled with the third cavity through second wall perforation(s).

### BACKGROUND

### 1. Technical Field

This disclosure relates generally to an aircraft and, more particularly, to an acoustic panel for the aircraft.

### 2. Background Information

An aircraft propulsion system may include one or more acoustic panels for attenuating sound generated by its gas turbine engine. Various types and configurations of acoustic panels are known in the art. While these known acoustic panels have various benefits, there is still room in the art for improvement.

### SUMMARY OF THE DISCLOSURE

According to an aspect of the present disclosure, an apparatus is provided for an aircraft. This apparatus includes an acoustic panel, and the acoustic panel includes a face skin, a septum, a back skin, a face core and a back core. The face core is disposed vertically between and is connected to the face skin and the septum. The face core includes a plurality of face core cavities that extend vertically through the face core from the face skin to the septum. Each of the face core cavities is fluidly coupled with one or more face skin perforations in the face skin. The back core is disposed vertically between and is connected to the septum and the back skin. The back core includes a plurality of back core walls and a plurality of back core cavities. The back core walls includes a first wall and a second wall. The back core cavities extend vertically through the back core from the septum to the back skin. Each of the back core cavities is fluidly coupled with a respective one of the face core cavities through one or more septum perforations in the septum. The back core cavities include a first cavity, a second cavity and a third cavity. The first cavity is fluidly coupled with the second cavity through one or more first wall perforations in the first wall. The first cavity is fluidly coupled with the third cavity through one or more second wall perforations in the second wall.

According to another aspect of the present disclosure, another apparatus is provided for an aircraft. This apparatus includes an acoustic panel, and the acoustic panel includes a face skin, a septum, a back skin, a face core and a back core. The face core is disposed vertically between and is connected to the face skin and the septum. The face core includes a plurality of face core cavities that extend vertically through the face core from the face skin to the septum. Each of the face core cavities is fluidly coupled with one or more face skin perforations in the face skin. The back core is disposed vertically between and is connected to the septum and the back skin. The back core includes a plurality of back core chambers that are fluidly separate from one another within the back core. Each of the back core chambers includes a respective set of a plurality of back core cavities that are fluidly coupled with one another within the back core. Each of the back core cavities is fluidly coupled with at least a respective one of the face core cavities through one or more septum perforations in the septum.

According to still another aspect of the present disclosure, another apparatus is provided for an aircraft. This apparatus includes an acoustic panel, and the acoustic panel includes a face skin, a septum, a back skin, a face core and a back core. The face core is disposed vertically between and is connected to the face skin and the septum. The face core includes a plurality of face core cavities that extend vertically through the face core from the face skin to the septum. Each of the face core cavities is fluidly coupled with one or more face skin perforations in the face skin. The back core is disposed vertically between and is connected to the septum and the back skin. The back core includes a plurality of back core walls and a plurality of back core cavities. The back core walls include a first wall. The back core cavities extend vertically through the back core from the septum to the back skin. Each of the back core cavities is fluidly coupled with a respective one of the face core cavities through one or more septum perforations in the septum. The back core cavities include a first cavity and a second cavity. The first cavity is fluidly coupled with the second cavity through one or more first wall perforations in the first wall. A percentage of open area of the first wall is greater than a percentage of open area of the septum.

The percentage of open area of the first wall may be greater than a percentage of open area of the face skin.

The first cavity may be laterally between the second cavity and the third cavity. The first wall may be laterally between the first cavity and the second cavity. The second wall may be laterally between the first cavity and the third cavity.

The first wall may be laterally between the first cavity and the second cavity. The second wall may be laterally between the first cavity and the third cavity. The first wall may meet the second wall at a corner between the first wall and the second wall.

Each of the back core walls may extend vertically from the back skin to the septum.

Each of the face core cavities may have a first cross-sectional geometry. Each of the back core cavities may have a second cross-sectional geometry that is different than the first cross-sectional geometry.

Each of the face core cavities and the back core cavities may have a uniform cross-sectional geometry.

The back core cavities may also include a fourth cavity. The back core walls may also include a third wall. The third wall may be laterally between and may form peripheral boundaries of the second cavity and the fourth cavity. The third wall may fluidly decouple the second cavity from the fourth cavity.

The back core may also include a plurality of back core chambers that are fluidly discrete within the back core. Each of the back core chambers may include a respective array of the back core cavities.

The face core cavities may be fluidly discrete within the face core.

A vertical thickness of the face core may be equal to or greater than a vertical thickness of the back core.

A percentage of open area of the face skin may be equal to or greater than a percentage of open area of the septum.

A percentage of open area of the first wall may be equal to or greater than a percentage of open area of the face skin.

A percentage of open area of the first wall may be equal to or greater than a percentage of open area of the septum.

A percentage of open area of the first wall may be equal to or greater than three percent.

A first of the face core cavities may laterally overlap and may be fluidly coupled with the first cavity and the second cavity through the septum.

The first cavity may laterally overlap and may be fluidly coupled with multiple of the face core cavities.

The acoustic panel may extend axially along and circumferentially about an axis. The back skin may be disposed radially outboard of the face skin.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a partial side sectional illustration of an acoustic panel.

FIG. 2 is a partial cross-sectional illustration of the acoustic panel.

FIG. 3 is a plan view illustration of a portion of a cellular face core.

FIG. 4 is a perspective illustration of a portion of a cellular back core.

FIG. 5 is a perspective illustration of a portion of another cellular back core.

FIG. 6 is a perspective exploded illustration of elements in a portion of the acoustic panel.

### DETAILED DESCRIPTION

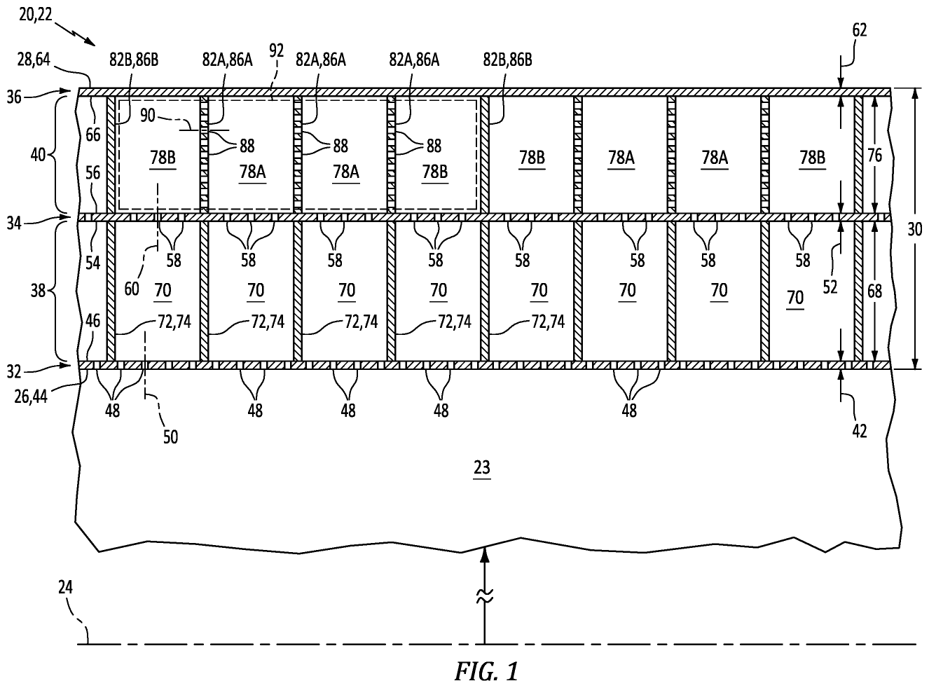

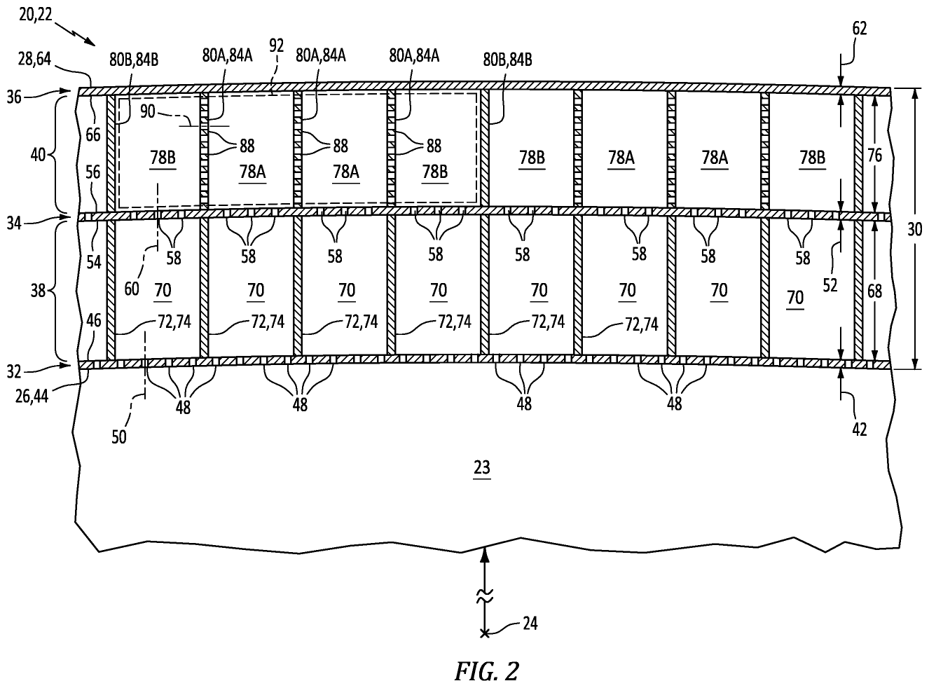

FIGS. 1 and 2 illustrate a structural, acoustic panel 20 for an aircraft. This acoustic panel 20 may be configured to attenuate sound (e.g., noise) generated by a propulsion system of the aircraft. The aircraft propulsion system may be a turbofan propulsion system, a turbojet propulsion system, a turboprop propulsion system or any other ducted-rotor and/or open-rotor aircraft propulsion system. The acoustic panel 20 may be part of a housing (e.g., a nacelle) for an engine (e.g., a gas turbine engine) of the aircraft propulsion system. The acoustic panel 20, for example, may be configured as or otherwise included as part of an inner barrel, an outer barrel, a translating sleeve, a blocker door, a bifurcation, etc. Alternatively, the acoustic panel 20 may be part of another component of the aircraft such as, but not limited to, an engine pylon, an aircraft wing or an aircraft fuselage. Furthermore, the acoustic panel 20 may also or alternatively be configured to attenuate aircraft related sound other than the sound generated by the aircraft propulsion system. However, for ease of description, the acoustic panel 20 of FIGS. 1 and 2 is described below as attenuating propulsion system sound and with respect to a component 22 (e.g., barrel) of the engine housing along a flowpath 23 (e.g., a bypass flowpath) within the aircraft propulsion system.

Referring to FIG. 1, the acoustic panel 20 extends axially along an axis 24. Briefly, this axis 24 may be a centerline axis of the aircraft propulsion system, a centerline axis of the engine housing and/or a centerline axis of the component 22 (e.g., the barrel) which is formed by or otherwise includes the acoustic panel 20. The acoustic panel 20 extends radially from a radial inner side 26 of the acoustic panel 20 to a radial outer side 28 of the acoustic panel 20. Referring to FIG. 2, the acoustic panel 20 extends circumferentially about (e.g., partially or completely around) the axis 24. The component 22 and/or its acoustic panel 20 may thereby have a curved (e.g., arcuate, cylindrical, conical, frustoconical) geometry.

With the arrangement of FIGS. 1 and 2, a vertical thickness 30 of the acoustic panel 20 extends in a radial direction relative to the axis 24, and a lateral plane of the acoustic panel 20 extends axially along and circumferentially about the axis 24. The present disclosure, however, is not limited to such an exemplary curved geometry nor such an orientation relative to the axis 24. For example, where the acoustic panel 20 is configured as or part of a sidewall of the bifurcation, the vertical thickness 30 may extend tangentially to a circular reference line about the axis 24, and the lateral plane may extend axially and/or radially relative to the axis 24. However, for case of description, the acoustic panel 20 is described below with reference to the orientation of FIGS. 1 and 2 where a vertical direction extends radially relative to the axis 24, a first lateral direction extends axially along the axis 24, and a second lateral direction extends circumferentially about the axis 24.

The acoustic panel 20 of FIGS. 1 and 2 includes a perforated face skin 32, a perforated septum 34, a solid (e.g., non-perforated) back skin 36, a cellular face core 38 (e.g., a face skin side core) and a cellular back core 40 (e.g., a back skin side core). For case of description, the face skin 32 is described below as an inner skin of the acoustic panel 20 and the back skin 36 is described below as an outer skin of the acoustic panel 20. With such an arrangement, the acoustic panel 20 and its face skin 32 may form an outer peripheral boundary of at least a portion of the flowpath 23 within the aircraft propulsion system. It is contemplated, however, the face skin 32 may alternatively be the acoustic panel outer skin and the back skin 36 may alternatively be the acoustic panel inner skin with otherwise the same acoustic panel configuration of FIGS. 1 and 2. With such an arrangement, the acoustic panel 20 and its face skin 32 may form an inner peripheral boundary of at least a portion of the flowpath 23 within the aircraft propulsion system. The present disclosure, of course, is not limited to the foregoing exemplary arrangements. The acoustic panel 20, for example, may form a circumferential side boundary of the flowpath 23 and/or may otherwise be located with the aircraft propulsion system and/or the aircraft.

The face skin 32 of FIGS. 1 and 2 extends axially along and circumferentially about the axis 24. The face skin 32 has a radial thickness 42. This face skin thickness 42 extends radially between opposing exterior and interior sides 44 and 46 of the face skin 32, where the face skin exterior side 44 is also the inner side 26 of the acoustic panel 20 of FIGS. 1 and 2. The face skin thickness 42 may remain uniform (e.g., constant, the same) as the face skin 32 extends axially along and/or circumferentially about the axis 24. Alternatively, the face skin thickness 42 may be varied as the face skin 32 extends axially along and/or circumferentially about the axis 24, for example, to structurally reinforce one or more areas of the acoustic panel 20, etc.

The face skin 32 may be formed as a relatively thin sheet of face skin material. This face skin material may be a composite material or a metal. The composite material may be a fiber-reinforced composite material. The face skin 32, for example, may include one or more layers of the face skin material arranged in a stack and bonded together to form a single monolithic member of the acoustic panel 20. The face skin material (e.g., each face skin layer) may include a polymer matrix and fiber reinforcement embedded within the polymer matrix. The polymer matrix may be a thermoset material (e.g., epoxy) or a thermoplastic material. The fiber reinforcement may include fiberglass fibers, carbon fiber fibers, aramid (e.g., Kevlar®) fibers and/or the like. The fiber reinforcement may be arranged as a (e.g., woven or unwoven) sheet of fibers and/or chopped fibers. In another example, the face skin 32 may be formed as a sheet of metal. The metal may be a pure metal or a metal alloy. This metal may be or otherwise include aluminum (Al), titanium (Ti) or steel (e.g., stainless steel). The present disclosure, however, is not limited to such exemplary face skin materials.

The face skin 32 includes a plurality of perforations 48; e.g., apertures such as through-holes. The face skin perforations 48 are distributed axially and/or circumferentially along the face skin 32 and may (or may not) be equispaced from one another along the face skin 32. Each of the face skin perforations 48 extends longitudinally along a centerline 50 of the respective face skin perforations 48 through the face skin 32 from the face skin exterior side 44 to the face skin interior side 46. The perforation centerline 50 of FIGS. 1 and 2 is perpendicular to the face skin sides 44, 46 at (e.g., on, adjacent or proximate) a location where the respective face skin perforation 48 pierces the face skin sides 44, 46. It is contemplated, however, the perforation centerline 50 may alternatively be (e.g., slightly) acutely angled relative to the face skin sides 44, 46.

The septum 34 of FIGS. 1 and 2 extends axially and circumferentially about the axis 24. The septum 34 has a radial thickness 52. This septum thickness 52 extends radially between opposing face core-side and back core-side sides 54 and 56 of the septum 34. The septum thickness 52 may remain uniform as the septum 34 extends axially along and/or circumferentially about the axis 24. Alternatively, the septum thickness 52 may be varied as the septum 34 extends axially along and/or circumferentially about the axis 24, for example, to structurally reinforce one or more areas of the acoustic panel 20, etc. Referring again to FIGS. 1 and 2, the septum thickness 52 may be equal to or different (e.g., less) than the face skin thickness 42.

The septum 34 may be formed as a relatively thin sheet of septum material. This septum material may be a composite material or a metal. The composite material may be a fiber-reinforced composite material. The septum 34, for example, may include one or more layers of the septum material arranged in a stack and bonded together to form a single monolithic member of the acoustic panel 20. The septum material (e.g., each septum layer) may include a polymer matrix and fiber reinforcement embedded within the polymer matrix. The polymer matrix may be a thermoset material (e.g., epoxy) or a thermoplastic material. The fiber reinforcement may include fiberglass fibers, carbon fiber fibers, aramid (e.g., Kevlar®) fibers and/or the like. The fiber reinforcement may be arranged as a (e.g., woven or unwoven) sheet of fibers and/or chopped fibers. In another example, the septum 34 may be formed as a sheet of metal. The metal may be a pure metal or a metal alloy. This metal may be or otherwise include aluminum (Al), titanium (Ti) or steel (e.g., stainless steel). The present disclosure, however, is not limited to such exemplary septum materials. Moreover, while the septum 34 is described as a relatively thin sheet of the septum material, it is contemplated the septum 34 may alternatively be formed as a relatively thin sheet of mesh; e.g., a woven or non-woven screen or the like.

The septum 34 includes a plurality of perforations 58; e.g., apertures such as through-holes, interstices between screen members, etc. The septum perforations 58 are distributed axially and/or circumferentially along the septum 34 and may (or may not) be equispaced from one another along the septum 34. Each of the septum perforations 58 extends longitudinally along a centerline 60 of the respective septum perforations 58 through the septum 34 between the opposing septum sides 54 and 56. The perforation centerline 60 of FIGS. 1 and 2 is perpendicular to the septum sides 54, 56 at a location where the respective septum perforation 58 pierces the septum sides 54, 56. It is contemplated, however, the perforation centerline 60 may alternatively be (e.g., slightly) acutely angled relative to the septum sides 54, 56.

The back skin 36 of FIGS. 1 and 2 extends axially along and circumferentially about the axis 24. The back skin 36 has a radial thickness 62. This back skin thickness 62 extends radially between opposing exterior and interior sides 64 and 66 of the back skin 36, where the back skin exterior side 64 is also the outer side 28 of the acoustic panel 20 of FIGS. 1 and 2. The back skin thickness 62 may remain uniform (e.g., constant, the same) as the back skin 36 extends axially along and/or circumferentially about the axis 24. Alternatively, the back skin thickness 62 may be varied as the back skin 36 extends axially along and/or circumferentially about the axis 24, for example, to structurally reinforce one or more areas of the acoustic panel 20, etc. Referring again to FIGS. 1 and 2, the back skin thickness 62 may be equal to or different (e.g., greater) than the face skin thickness 42 and/or the septum thickness 52.

The back skin 36 may be formed as a relatively thin sheet of back skin material. This back skin material may be a composite material or a metal. The composite material may be a fiber-reinforced composite material. The back skin 36, for example, may include one or more layers of the back skin material arranged in a stack and bonded together to form a single monolithic member of the acoustic panel 20. The back skin material (e.g., each back skin layer) may include a polymer matrix and fiber reinforcement embedded within the polymer matrix. The polymer matrix may be a thermoset material (e.g., epoxy) or a thermoplastic material. The fiber reinforcement may include fiberglass fibers, carbon fiber fibers, aramid (e.g., Kevlar®) fibers and/or the like. The fiber reinforcement may be arranged as a (e.g., woven or unwoven) sheet of fibers and/or chopped fibers. In another example, the back skin 36 may be formed as a sheet of metal. The metal may be a pure metal or a metal alloy. This metal may be or otherwise include aluminum (Al), titanium (Ti) or steel (e.g., stainless steel). The present disclosure, however, is not limited to such exemplary back skin materials.

Referring to FIGS. 1 and 2, the face core 38 is arranged and extends radially between the face skin 32 and the septum 34. One side of the face core 38, for example, may be abutted radially against the face skin interior side 46. Another side of the face core 38 may be abutted radially against the septum face core-side side 54. The face core 38 may also be connected to the face skin 32 and/or the septum 34. The face core 38, for example, may be fused, adhered and/or otherwise bonded to the face skin 32 and/or the septum 34.

The face core 38 of FIGS. 1 and 2 extends axially along and circumferentially about the axis 24. The face core 38 has a radial thickness 68. This face core thickness 68 extends radially between and to the face skin 32 at its face skin interior side 46 and the septum 34 at its septum face core-side side 54. The face core thickness 68 may remain uniform as the face core 38 extends axially along and/or circumferentially about the axis 24. The face core thickness 68 may be substantially larger than the face skin thickness 42, the septum thickness 52 and/or the back skin thickness 62. The face core thickness 68, for example, may be at least ten to forty times (10-40×), or more, larger than the face skin thickness 42, the septum thickness 52 and/or the back skin thickness 62. The face core 38 of the present disclosure, however, is not limited to such an exemplary dimensional relationship and may vary based on sound attenuation requirements, space requirements, etc.

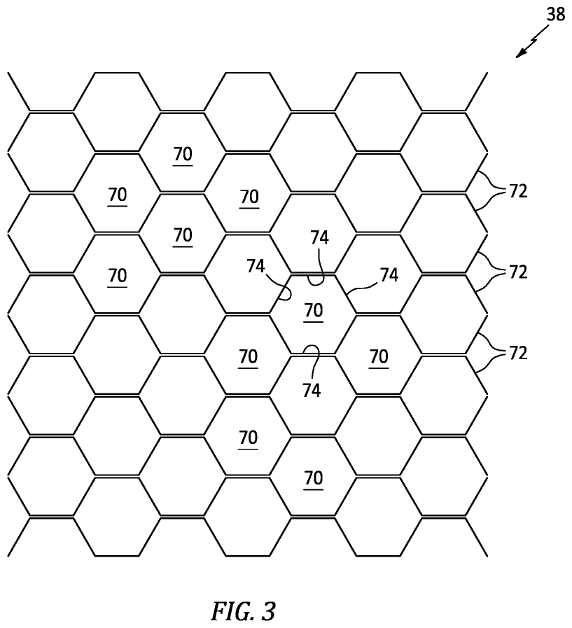

The face core 38 of FIGS. 1 and 2 is configured with one or more internal face core cavities 70 (e.g., open internal chambers, acoustic resonance chambers, etc.) radially between the face skin 32 and the septum 34. Referring to FIG. 3, the face core 38 may be configured as a honeycomb core. The face core 38 of FIG. 3, for example, includes a plurality of corrugated face core sidewalls 72. These face core sidewalls 72 are arranged in a side-by-side array and are connected to one another such that each neighboring (e.g., adjacent) pair of the face core sidewalls 72 forms an array of the face core cavities 70 laterally (e.g., circumferentially and/or axially) therebetween. The face core 38 and its face core sidewalls 72 may be constructed from or otherwise include a core material such as metal; e.g., sheet metal. The present disclosure, however, is not limited to such an exemplary face core construction nor material. For example, in other embodiments, the face core 38 and its face core sidewalls 72 may be constructed from or otherwise include a composite material similar to or the same as one or more of the panel elements 32, 34, 36.

Each face core cavity 70 of FIGS. 1 and 2 extends radially within/through the face core 38 along a respective centerline of the respective face core cavity 70 between and to the face skin 32 at its face skin interior side 46 and the septum 34 at its septum face core-side side 54. One or more or all of the face core cavities 70 may thereby each overlap and be fluidly coupled with a respective set of one or more of the face skin perforations 48 and/or a respective set of one or more of the septum perforations 58. Referring to FIG. 3, each of the face core cavities 70 has a cross-sectional geometry (e.g., shape, size, etc.) when viewed in a reference plane; e.g., a plane perpendicular to the cavity centerline of the respective face core cavity 70. This cavity cross-sectional geometry of FIG. 3 has a hexagonal shape. The present disclosure, however, is not limited to such an exemplary face core configuration. The cavity cross-sectional geometry, for example, may alternatively have another polygonal shape such as, but not limited to, a square shape, a rectangular shape, a triangular shape, etc. In another example, the cavity cross-sectional geometry may have a circular, elliptical or other non-polygonal cross-sectional geometry.

The face core 38 may be configured as a solid-wall cellular core. Each of the face core sidewalls 72 of FIGS. 1 and 2, for example, includes an array of side-by-side face core walls 74; e.g., face core cavity sidewalls. Each of these face core walls 74 of FIGS. 1 and 2 is configured as a solid (e.g., non-perforated) wall. The face core walls 74 of FIGS. 1 and 2 surrounding and forming lateral side peripheral boundaries of a respective face core cavity 70 thereby separate and fluidly decouple (within the face core 38) that face core cavity 70 from each laterally (e.g., axially and/or circumferentially) neighboring face core cavity 70.

The back core 40 is arranged and extends radially between the back skin 36 and the septum 34. One side of the back core 40, for example, may be abutted radially against the back skin interior side 66. Another side of the back core 40 may be abutted radially against the septum back core-side side 56. The back core 40 may also be connected to the back skin 36 and/or the septum 34. The back core 40, for example, may be fused, adhered and/or otherwise bonded to the back skin 36 and/or the septum 34.

The back core 40 of FIGS. 1 and 2 extends axially along and circumferentially about the axis 24. The back core 40 has a radial thickness 76. This back core thickness 76 extends radially between and to the back skin 36 at its back skin interior side 66 and the septum 34 at its septum back core-side side 56. The back core thickness 76 may remain uniform as the back core 40 extends axially along and/or circumferentially about the axis 24. The back core thickness 76 may be substantially larger than the face skin thickness 42, the septum thickness 52 and/or the back skin thickness 62. The back core thickness 76, for example, may be at least ten to forty times (10-40×), or more, larger than the face skin thickness 42, the septum thickness 52 and/or the back skin thickness 62. The back core thickness 76 may also be equal to or different (e.g., less) than the face core thickness 68. The back core 40 of the present disclosure, however, is not limited to such an exemplary dimensional relationship and may vary based on sound attenuation requirements, space requirements, etc.

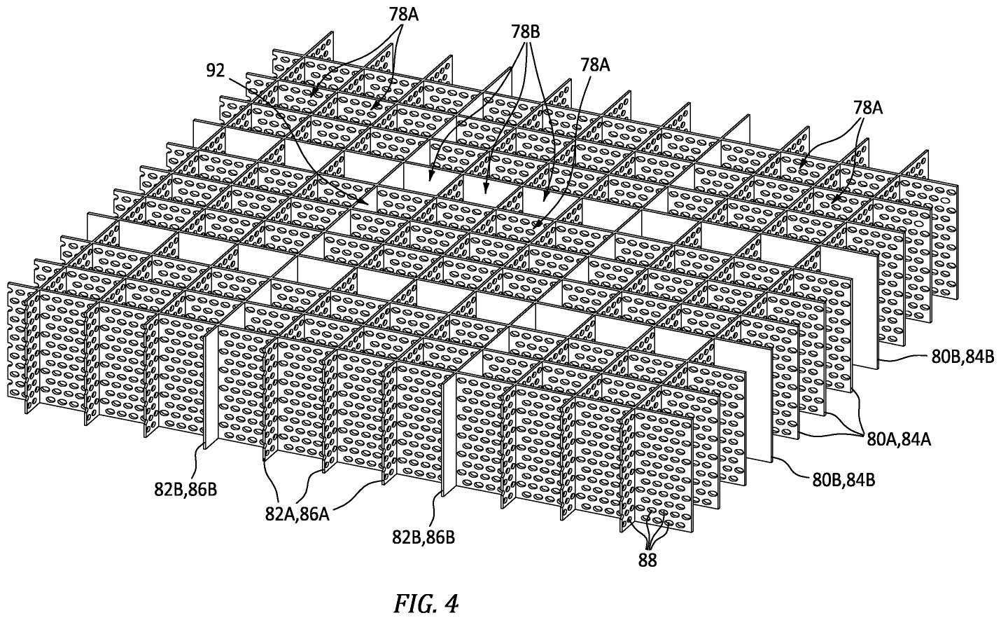

The back core 40 of FIGS. 1 and 2 is configured with one or more internal back core cavities 78A and 78B (generally referred to as “78”) (e.g., open internal chambers, acoustic resonance chambers, etc.) radially between the back skin 36 and the septum 34. Referring to FIG. 4, the back core 40 may be configured as a square-cell core. The back core 40 of FIG. 4, for example, includes a plurality of planar first back core sidewalls 80A and 80B (generally referred to as “80”) and a plurality of planar second back core sidewalls 82A and 82B (generally referred to as “82”). The first back core sidewalls 80 are arranged (e.g., and equispaced) in an array extending in the first lateral direction (e.g., circumferentially about the axis 24). The second back core sidewalls 82 are arranged (e.g., and equispaced) in an array extending in the second lateral direction (e.g., axially along the axis 24), where this second back core sidewall array crosses the first back core sidewall array. The back core sidewalls 80 and 82 thereby collectively form the back core cavities 78 within the back core 40, where each back core cavity 78 extends laterally in the first lateral direction between a respective neighboring pair of the first back core sidewalls 80, and where each back core cavity 78 extends laterally in the second lateral direction between a respective neighboring pair of the second back core sidewalls 82. The back core 40 and its back core sidewalls 80, 82 may be constructed from or otherwise include a core material such as metal; e.g., sheet metal. The present disclosure, however, is not limited to such an exemplary back core construction nor material. For example, in other embodiments, the back core 40 and its back core sidewalls 80, 82 may be constructed from or otherwise include a composite material similar to or the same as one or more of the panel elements 32, 34, 36.

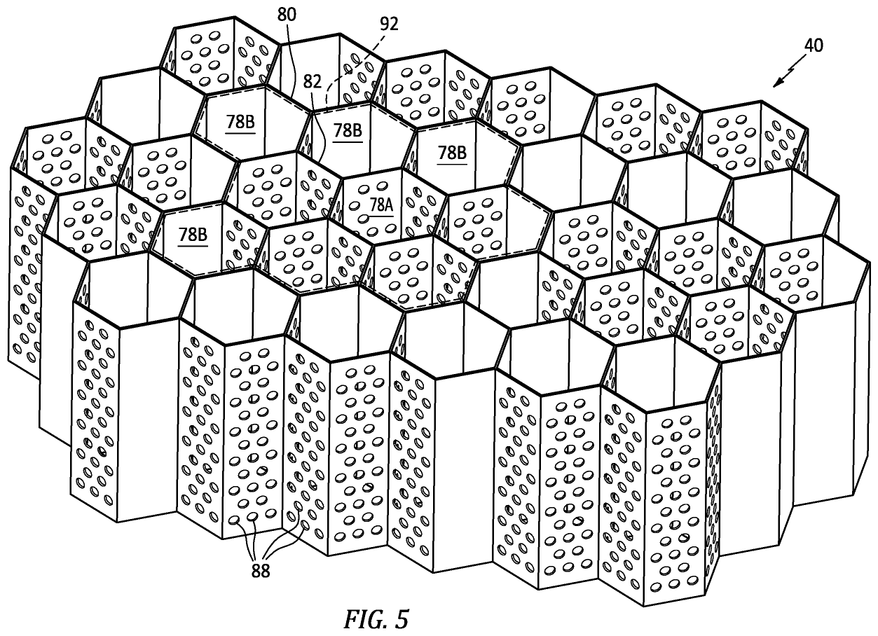

Each back core cavity 78 of FIGS. 1 and 2 extends radially within/through the back core 40 along a respective centerline of the respective back core cavity 78 between and to the back skin 36 at its back skin interior side 66 and the septum 34 at its septum back core-side side 56. One or more or all of the back core cavities 78 may thereby each overlap and be fluidly coupled with a respective set of one or more of the septum perforations 58. Briefly, each set of the septum perforation(s) 58 fluidly couples each back core cavity 78 with one or more of the face core cavities 70 which laterally (e.g., axially and/or circumferentially) overlap the respective back core cavity 78. Similarly, each set of the septum perforation(s) 58 fluidly couples each face core cavity 70 with one or more of the back core cavities 78 which laterally (e.g., axially and/or circumferentially) overlap the respective face core cavity 70. Referring to FIG. 4, each of the back core cavities 78 has a cross-sectional geometry (e.g., shape, size, etc.) when viewed in a reference plane; e.g., a plane perpendicular to the cavity centerline of the respective back core cavity 78. This cavity cross-sectional geometry of FIG. 4 has a square shape. The present disclosure, however, is not limited to such an exemplary back core configuration. The cavity cross-sectional geometry, for example, may alternatively have another polygonal shape such as, but not limited to, a hexagonal shape (e.g., see FIG. 5), a rectangular shape, a triangular shape, etc. In another example, the cavity cross-sectional geometry may have a circular, elliptical or other non-polygonal cross-sectional geometry.

The back core 40 may be configured as a perforated wall cellular core. Each of the back core sidewalls 80A, 82A of FIGS. 1 and 2, for example, is a perforated sidewall. More particularly, each of the back core sidewalls 80A, 82A of FIGS. 1 and 2 includes an array of side-by-side perforated back core walls 84A, 86A; e.g., back core cavity sidewalls. However, each of the back core sidewalls 80B, 82B of FIGS. 1 and 2 may be a solid (e.g., non-perforated) sidewall. More particularly, each of the back core sidewalls 80B, 82B of FIGS. 1 and 2 includes an array of side-by-side solid (e.g., non-perforated) back core walls 84B, 86B; e.g., back core cavity sidewalls. The back core walls 84A, 84B, 86A and/or 86B of FIGS. 1 and 2 surrounding and forming lateral side peripheral boundaries of a respective back core cavity 78 thereby separate that back core cavity 78 from each laterally (e.g., axially and/or circumferentially) neighboring back core cavity 78.

Each perforated back core wall 84A, 86A includes one or more perforations 88; e.g., apertures such as through-holes, interstices between screen members, etc. The wall perforations 88 are distributed vertically and/or laterally (e.g., axially or circumferentially) along the perforated back core wall 84A, 86A and may (or may not) be equispaced from one another along the perforated back core wall 84A, 86A. Referring to FIGS. 1 and 2, each wall perforation 88 extends longitudinally along a centerline 90 of the respective wall perforation 88 through the respective perforated back core wall 84A, 86A. The perforation centerline 90 of FIGS. 1 and 2 is perpendicular to opposing lateral sides of the respective perforated back core wall 84A, 86A at a location where the respective wall perforation 88 pierces the respective perforated back core wall 84A, 86A. It is contemplated, however, the perforation centerline 90 may alternatively be (e.g., slightly) acutely angled relative to the opposing lateral sides of the respective perforated back core wall 84A, 86A.

Referring to FIGS. 1, 2 and 4, each back core wall 84A, 84B extends laterally (e.g., axially) between and is connected to a respective neighboring (e.g., adjacent) pair of the back core walls 86A, 86B. Each back core wall 84A, 84B may also meet each neighboring back core wall 86A, 86B at a corner therebetween. Similarly, each back core wall 86A, 86B extends laterally (e.g., circumferentially) between and is connected to a respective neighboring (e.g., adjacent) pair of the back core walls 84A, 84B. Each back core wall 86A, 86B may also meet each neighboring back core wall 84A, 84B at a corner therebetween.

With the arrangement of FIGS. 1 and 2, the wall perforation(s) 88 in each perforated back core wall 84A, 86A fluidly couple the respective back core cavities 78 to the opposing lateral sides of that perforated back core wall 84A, 86A. Conversely, the respective back core cavities 78 to the opposing lateral sides of each solid back core wall 84B, 86B are fluidly decoupled from one another within the back core 40. The back core cavities 78 may thereby be grouped into a plurality of back core chambers 92 which are fluidly separate/fluidly decoupled from one another within the back core 40. However, the back core cavities 78 within each of the back core chambers 92 are fluidly coupled with one another within the back core 40. The back core cavities 78 within each of the back core chambers 92 thereby form sub-chambers of the respective back core chamber 92.

The acoustic panel 20 of FIGS. 1 and 2 is configured as a multi-degree of freedom acoustic panel. For example, a respective face core cavity 70 provides a first degree of freedom. Crossing the septum 34 into a respective back core cavity 78 provides a second degree of freedom. Crossing a respective perforated back core wall 84A, 86A into another respective back core cavity 78 provides a third degree of freedom, and so on across the other respective perforated back core wall 84A, 86A associated with a respective back core chamber 92. With such an arrangement, the acoustic panel 20 may be tuned to attenuate multiple (e.g., a broad band of) frequencies of sound, which tuning may be based on (A) a radial height of each face core cavity 70, (B) a radial height of each back core cavity 78, (C) a lateral width of each back core cavity 78, (D) a number of the back core cavities 78 included in a respective back core chamber 92, etc.

During operation of the acoustic panel 20 of FIGS. 1 and 2, sound waves may enter a respective face core cavity 70 through the respective face skin perforation(s) 48. Some of these sound waves may travel through the respective face core cavity 70 and reflect against the septum 34. The reflected sound waves may travel back through the respective face core cavity 70 and exit the acoustic panel 20 through the respective face skin perforation(s) 48, where those reflected sound waves may be out of phase from and destructively interfere with incoming soundwaves. Others of the sound waves may travel from the respective face core cavity 70 through the respective septum perforation(s) 58 and into a respective back core cavity 78. These sound waves may reflect against the back skin 36 and travel back through the respective back core cavity 78, the respective septum perforation(s) 58, the respective face core cavity 70 and respective face skin perforation(s) 48, where those reflected sound waves may be out of phase from and destructively interfere with other incoming soundwaves. Still others of the sound waves may travel from the respective back core cavity 78 through the respective wall perforation(s) 88 into one or more other respective back core cavities 78 to provide additional reflected sound waves for attenuation. Of course, the sound waves may also or alternatively reflect against one or more other elements of the acoustic panel 20 which may further influence sound attenuation.

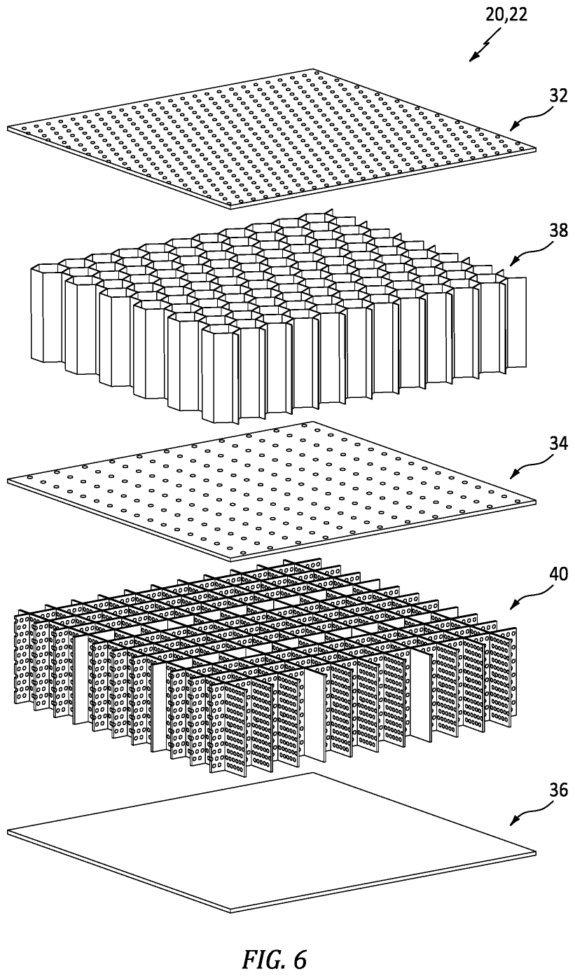

In some embodiments, referring to FIGS. 3 and 4, the cross-sectional geometry (e.g., size, shape, etc.) of one, some or all of the face core cavities 70 (see FIG. 3) may be different than the cross-sectional geometry (e.g., size, shape, etc.) of one, some or all of the back core cavities 78 (see FIG. 4); see also FIG. 6. A cross-sectional shape of each face core cavity 70, for example, may be different than a cross-sectional shape of each back core cavity 78. In addition or alternatively, a lateral dimension (e.g., a width) of each face core cavity 70 may be different than a lateral dimension (e.g., a width) of each back core cavity 78. In other embodiments, referring to FIGS. 3 and 5, cross-sectional geometry (e.g., size, shape, etc.) of one, some or all of the face core cavities 70 (see FIG. 3) may be similar to or the same as the cross-sectional geometry (e.g., size, shape, etc.) of one, some or all of the back core cavities 78 (see FIG. 5).

Each panel element 32, 34, 84A, 86A of FIGS. 1 and 2 has a respective percentage of open area (POA). The term “percentage of open area” may describe a percentage of a face surface of a panel element that is occupied by open area, where the open area is collectively formed by perforations in the panel element and piercing the face surface. By increasing the percentage of open area of the panel element, an acoustic resistance of the panel element may be decreased. By decreasing the percentage of open area of the panel element, the acoustic resistance of the panel element may be increased. This percentage of open area is related to various perforation parameters including, but not limited to, perforation size (e.g., diameter), perforation cross-sectional shape, and perforation density and, thus, a quantity of perforations included in the respective panel element. With respect to the arrangement of FIGS. 1 and 2, the percentage of open area of the face skin 32 may be equal to or greater than the percentage of open area of the septum 34. The percentage of open area of each back core wall 84A, 86A may be equal to or greater than the percentage of open area of the septum 34 and/or the face skin 32. In some embodiments, the percentage of open area of the face skin 32 may be between three percent (3%) and eighteen percent (18%), and the percentage of open area of the septum 34 may be greater than two percent (2%). The percentage of open area of one, some or all of the back core walls 84A, 86A may be between four percent (4%) and thirty-four percent (34%). The present disclosure, however, is not limited to the foregoing exemplary percentages of open area, and these percentages of open area may vary based on the specific acoustic attenuation requirements for the acoustic panel 20. For example, it is contemplated the percentage of open area of each back core wall 84A, 86A may alternatively be less than the percentage of open area of the face skin 32 under select acoustic conditions.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. An apparatus for an aircraft, comprising:
an acoustic panel including a face skin, a septum, a back skin, a face core and a back core;
the face core disposed vertically between and connected to the face skin and the septum, the face core comprising a plurality of face core cavities that extend vertically through the face core from the face skin to the septum, and each of the plurality of face core cavities fluidly coupled with one or more face skin perforations in the face skin; and
the back core disposed vertically between and connected to the septum and the back skin, the back core comprising a plurality of back core walls and a plurality of back core cavities, the plurality of back core walls including a first wall and a second wall, the plurality of back core cavities extending vertically through the back core from the septum to the back skin, each of the plurality of back core cavities fluidly coupled with a respective one of the plurality of face core cavities through one or more septum perforations in the septum, the plurality of back core cavities including a first cavity, a second cavity and a third cavity, the first cavity fluidly coupled with the second cavity through one or more first wall perforations in the first wall, and the first cavity fluidly coupled with the third cavity through one or more second wall perforations in the second wall.

2. The apparatus of claim 1, wherein
the first cavity is laterally between the second cavity and the third cavity;
the first wall is laterally between the first cavity and the second cavity; and
the second wall is laterally between the first cavity and the third cavity.

3. The apparatus of claim 1, wherein
the first wall is laterally between the first cavity and the second cavity;
the second wall is laterally between the first cavity and the third cavity; and
the first wall meets the second wall at a corner between the first wall and the second wall.

4. The apparatus of claim 1, wherein each of the plurality of back core walls extends vertically from the back skin to the septum.

5. The apparatus of claim 1, wherein
each of the plurality of face core cavities has a first cross-sectional geometry; and
each of the plurality of back core cavities has a second cross-sectional geometry that is different than the first cross-sectional geometry.

6. The apparatus of claim 1, wherein each of the plurality of face core cavities and the plurality of back core cavities has a uniform cross-sectional geometry.

7. The apparatus of claim 1, wherein
the plurality of back core cavities further include a fourth cavity;
the plurality of back core walls further includes a third wall; and
the third wall is laterally between and forms peripheral boundaries of the second cavity and the fourth cavity, and the third wall fluidly decouples the second cavity from the fourth cavity.

8. The apparatus of claim 1, wherein
the back core further comprises a plurality of back core chambers that are fluidly discrete within the back core; and
each of the plurality of back core chambers includes a respective array of the plurality of back core cavities.

9. The apparatus of claim 1, wherein the plurality of face core cavities are fluidly discrete within the face core.

10. The apparatus of claim 1, wherein a vertical thickness of the face core is equal to or greater than a vertical thickness of the back core.

11. The apparatus of claim 1, wherein a percentage of open area of the face skin is equal to or greater than a percentage of open area of the septum.

12. The apparatus of claim 1, wherein a percentage of open area of the first wall is equal to or greater than a percentage of open area of the face skin.

13. The apparatus of claim 1, wherein a percentage of open area of the first wall is equal to or greater than a percentage of open area of the septum.

14. The apparatus of claim 1, wherein a percentage of open area of the first wall is equal to or greater than three percent.

15. The apparatus of claim 1, wherein a first of the plurality of face core cavities laterally overlaps and is fluidly coupled with the first cavity and the second cavity through the septum.

16. The apparatus of claim 1, wherein the first cavity laterally overlaps and is fluidly coupled with multiple of the plurality of face core cavities.

17. The apparatus of claim 1, wherein
the acoustic panel extends axially along and circumferentially about an axis; and
the back skin is disposed radially outboard of the face skin.

18. An apparatus for an aircraft, comprising:
an acoustic panel including a face skin, a septum, a back skin, a face core and a back core;
the face core disposed vertically between and connected to the face skin and the septum, the face core comprising a plurality of face core cavities that extend vertically through the face core from the face skin to the septum, and each of the plurality of face core cavities fluidly coupled with one or more face skin perforations in the face skin; and
the back core disposed vertically between and connected to the septum and the back skin, the back core comprising a plurality of back core chambers that are fluidly separate from one another within the back core, each of the plurality of back core chambers comprising a respective set of a plurality of back core cavities that are fluidly coupled with one another within the back core, and each of the plurality of back core cavities fluidly coupled with at least a respective one of the plurality of face core cavities through one or more septum perforations in the septum.

19. An apparatus for an aircraft, comprising:
an acoustic panel including a face skin, a septum, a back skin, a face core and a back core;
the face core disposed vertically between and connected to the face skin and the septum, the face core comprising a plurality of face core cavities that extend vertically through the face core from the face skin to the septum, and each of the plurality of face core cavities fluidly coupled with one or more face skin perforations in the face skin; and
the back core disposed vertically between and connected to the septum and the back skin, the back core comprising a plurality of back core walls and a plurality of back core cavities, the plurality of back core walls comprising a first wall, the plurality of back core cavities extending vertically through the back core from the septum to the back skin, each of the plurality of back core cavities fluidly coupled with a respective one of the plurality of face core cavities through one or more septum perforations in the septum, the plurality of back core cavities including a first cavity and a second cavity, the first cavity fluidly coupled with the second cavity through one or more first wall perforations in the first wall, and a percentage of open area of the first wall greater than a percentage of open area of the septum.

20. The apparatus of claim 19, wherein the percentage of open area of the first wall is greater than a percentage of open area of the face skin.
